(19) United States
(12) Patent Application Publication
(10) Pub. No.: US 2005/0262761 A1
(43) Pub. Date: Dec. 1, 2005

(54) Mobile field scorching apparatus

(76) Inventors: Michael E. Carroll, Indian Wells, CA (US); Heulan D. Whitfield, Indio Hills, CA (US); Richard C. Clark, Palm Desert, CA (US)

Correspondence Address: DENNISON, SCHULTZ, DOUGHERTY & MACDONALD, 1727 KING STREET, SUITE 105, ALEXANDRIA, VA, 22314, US

(21) Appl. No.: 10/855,701

(22) Filed: May 28, 2004

(51) Int. Cl. A01M 15/00

(52) U.S. Cl. 47/1.44

(57) ABSTRACT

The present invention provides a mobile field scorching apparatus having a chassis, a plurality of wheels rotatably supporting the chassis on the ground, a main body placed over the chassis, a brush bar rotatably attached to the chassis for loosening the thatch on a grass area, a flame blower operably attached to the chassis and positioned rear the brush bar for scorching the loosened grass thatch, and a water discharge apparatus operably attached to the chassis rear the flame blower for wetting down and curtaining the scorched grass.

### TECHNICAL FIELD

The present invention is related to field scorching apparatus, and more specifically, to a mobile field scorching apparatus for loosening and scorching grass thatch, or scorching weeds, and subsequently wetting down the scorched grass to create fertilizer.

### BACKGROUND OF THE INVENTION

The grass in golf courses or residential areas is scalped during the fall season. Scalping requires cutting the grass very short and then reseeding it with winter rye. A problem associated with this method of scalping is that once the grass is cut, it leaves a residue on the soil that tends to blow around and create environmental issues. To address this problem, it is a common practice to pick up the cut grass using sweepers. However, the grass must be hauled away at additional cost. Also, not only sweepers cannot pick up all the grass, this process creates a lot of dust and air pollution.

Furthermore, to prevent fire, there is a need to control the growth of grass and weeds in the areas along the side of the freeways. One method for controlling the growth of weed and grass along the side of freeways is to use chemicals. However, in some states, the law prohibits the use of chemicals to kill weed and grass along the side of freeways. Another method to control the growth of grass is to mow the grass, however, the mowed grass creates additional fire hazard.

Therefore, there is a need for an apparatus to retard the growth of weed and grass along the side of freeways safely without the use of chemicals. Also, for golf courses, there is a further need for an apparatus to prepare the Bermuda grass so that winter rye may be planted. That is, there is a need for an apparatus that scorches the grass and deposits the scorched grass into the soil in a wet state, which allows for reseeding without waiting for one to two weeks.

### SUMMARY OF THE INVENTION

These problems and others are addressed by the present invention which comprises a mobile field scorching apparatus having a chassis, a plurality of wheels rotatably supporting the chassis on the ground, a main body placed over the chassis, a brush bar rotatably attached to the chassis for loosening the thatch on a grass area, a flame blower operably attached to the chassis and positioned rear the brush bar for scorching the loosened grass thatch, and a water discharge apparatus operably attached to the chassis rear the flame blower for wetting down and curtaining the scorched grass.

### BRIEF DESCRIPTION OF DRAWINGS

These and other objects of the present invention will be appreciated and understood by those skilled in the art from the detailed description of the preferred embodiments of the invention and the following drawings of which:

FIG. 1 is a left side perspective view of the mobile field scorching apparatus according to a first representative embodiment of the present invention;

FIG. 2 is a front perspective view of the mobile field scorching apparatus shown in FIG. 1;

FIG. 3 is a right side perspective view of the mobile field scorching apparatus of FIG. 1;

FIG. 4 is rear side perspective view of the mobile field scorching apparatus of FIG. 1;

FIG. 5 is a perspective view of the mobile field scorching apparatus of FIG. 1 without the cover portion illustrating the brush bar and the flame blower;

FIG. 6 is a perspective view of the mobile field scorching apparatus of FIG. 1 without the cover portion illustrating the water discharge apparatus;

FIG. 7 is a front elevational view of the mobile field scorching apparatus of FIG. 1;

FIG. 8 is a right side elevational view of the mobile field scorching apparatus of FIG. 1;

FIG. 9 is a rear sectional view of the cover portion and the brush bar of the mobile field burning apparatus of FIG. 1;

FIG. 10 is a rear perspective view of the cover portion and the flame blower of the mobile field scorching apparatus of FIG. 1;

FIG. 11 is a perspective view of the flame blower and the water discharge apparatus of the field scorching apparatus of FIG. 1; and,

FIG. 12 is a perspective view of the cover portion of the mobile field scorching apparatus of FIG. 1.

### DETAILED DESCRIPTION OF THE INVENTION

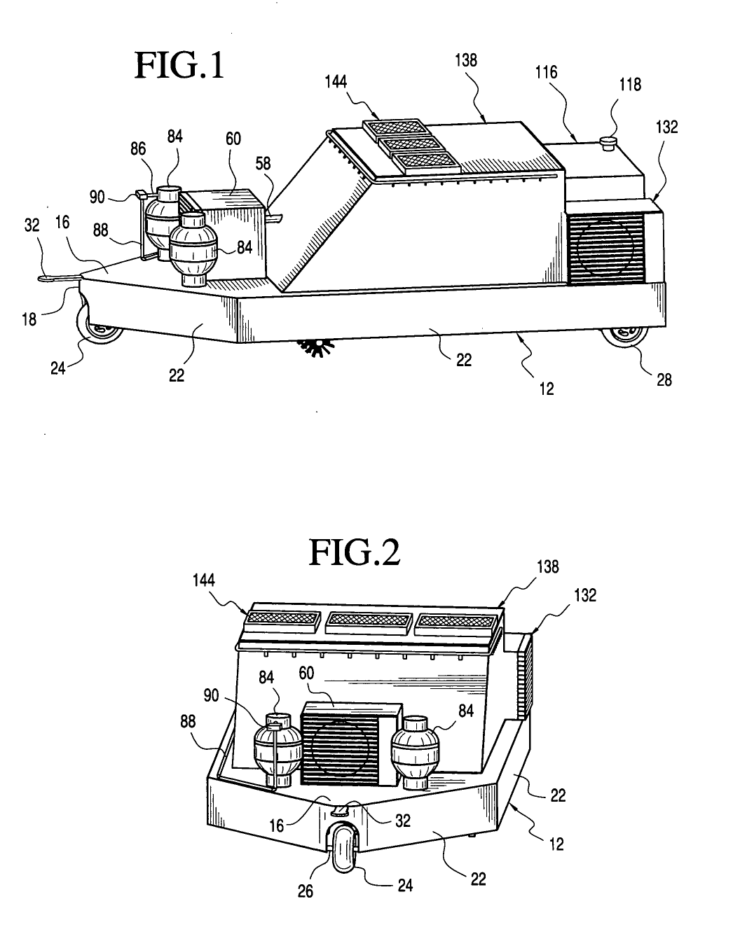

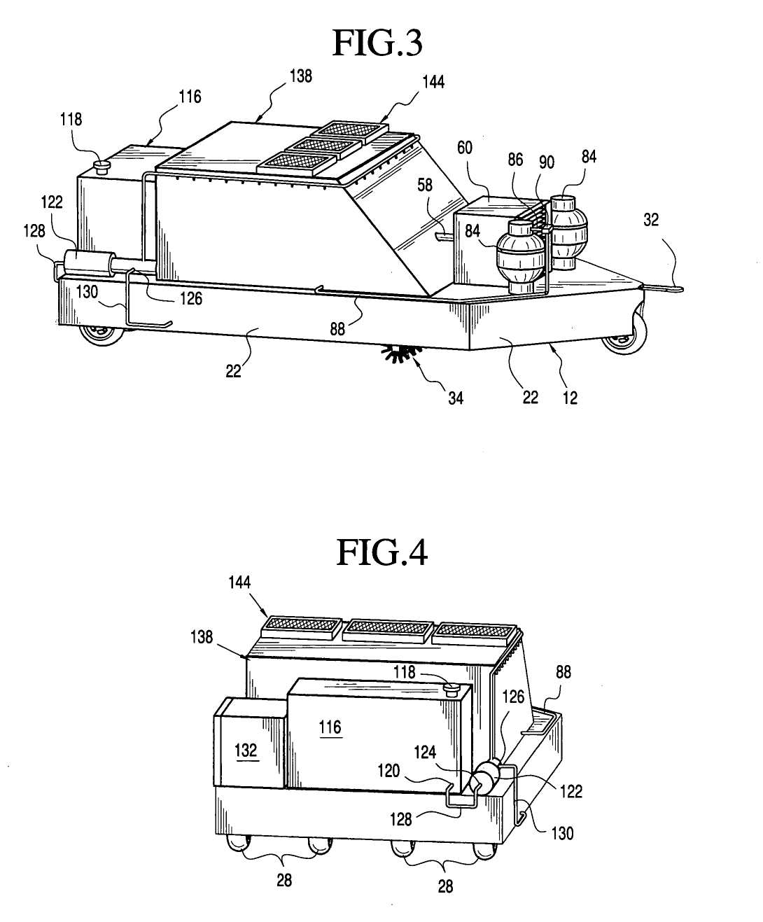

For the purpose of promoting and understanding of the principles of the invention, reference will now be made to the preferred embodiment illustrated in the drawings. Referring now to the drawings, and more specifically FIGS. 1 through 6, wherein the showings are for the purpose of illustrating the preferred embodiment of the invention only and not for the purpose of limiting the same, a mobile field scorching apparatus 10 comprises a main body 12 disposed on a chassis or support frame 14, wherein the main body 12 includes an upper support surface 16, a front end 18, a rear end 20, and a plurality of side panels 22 extending downwardly from the periphery of the upper surface 16 to bound an opening on an underside of the mobile field scorching apparatus 10.

The mobile field scorching apparatus 10 is movably supported on the ground by a front wheel 24 rotatably mounted on a front wheel axle 26 and a plurality of rear wheels 28 rotatably mounted on a rear wheel axle 30. The mobile field scorching apparatus 10 also includes a tow arm 32, and is preferably towed by a tractor. However, in an alternative embodiment, it is contemplated that the mobile field scorching apparatus 10 be independently driven.

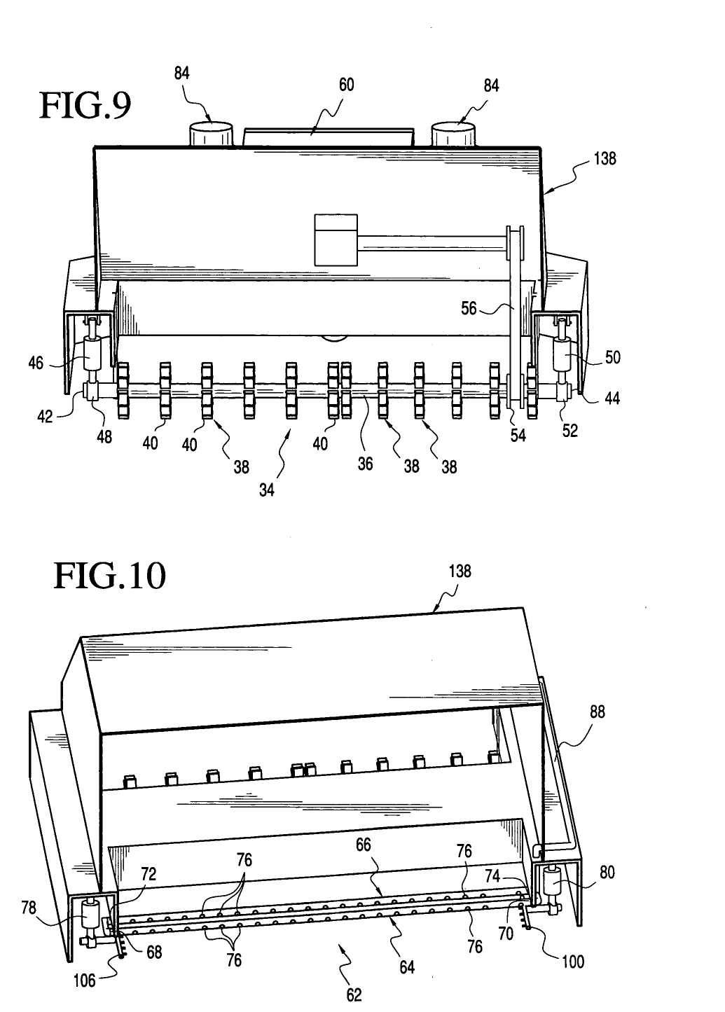

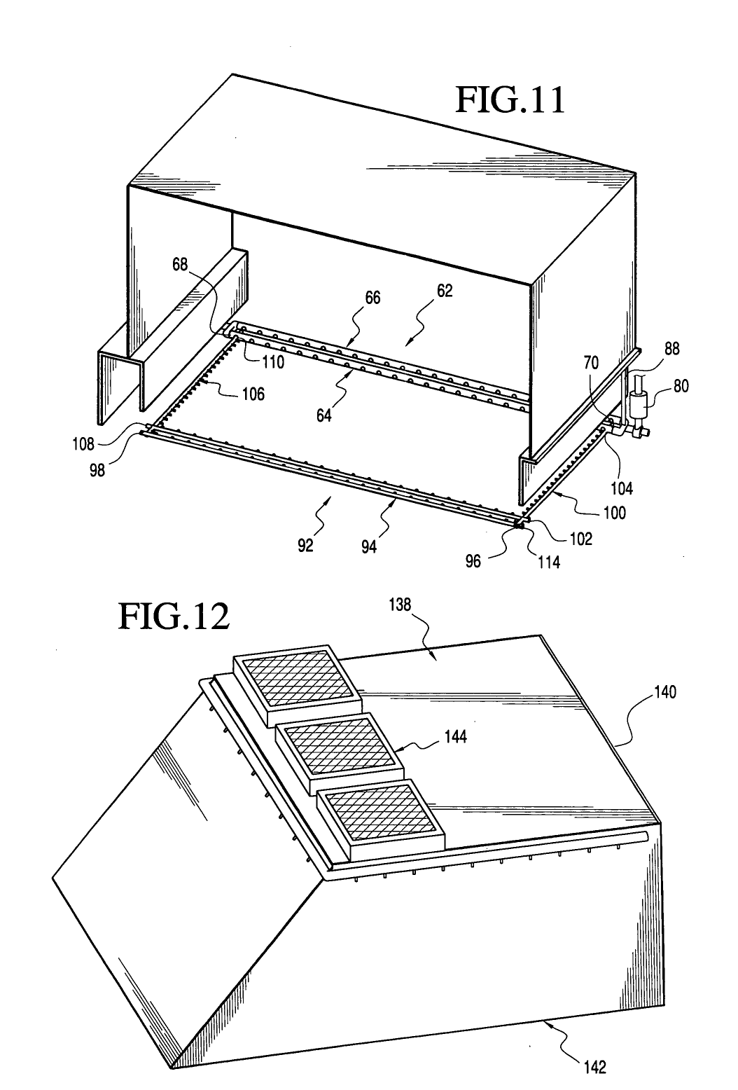

Referring now to FIG. 9, the mobile field scorching apparatus 10 further comprises an elongated brush bar 34 rotatably disposed underneath the chassis 12. The brush bar includes an axle 36 having a length substantially equal to the width of the chassis or support frame 14, and a plurality of brush segments 38 disposed along the length of the axle 36, wherein each brush segment 38 includes a plurality of teeth or fingers 40 removably and circumferentially disposed on the outer periphery of the axle 36. The teeth or fingers 40 are preferably made of rubber material or spring attached steel.

The axle 36 of the brush bar 34 includes a first end 42 and an opposing second end 44, wherein the first end 42 is rotatably mounted through a first bearing 48 on a first hydraulically extendible support arm 46 extending downwardly from an undersurface of the chassis 10, and the second opposing end 44 is also rotatably mounted through a second bearing 52 on a second hydraulically extendible support arm 50 extending downwardly from an undersurface of the chassis 10. The axle 36 of the brush bar 34 further includes a coupling means 54 at the second end 44, wherein the axles 36 is rotatable by means of a belt or chain 56 connected to the coupling means 54 at one end, and connected to an output shaft 58 of a gas or electric motor means 60 secured on the upper support surface 16 of the main body 12 at the second end.

The rotational speed of the brush bar 34 is controlled manually, however, it is contemplated that an electronic variable speed control can also be used to vary the rotational speed. As will be explained in greater detail herein, the first and second hydraulically extendible support arms 46, 50 are also powered by the gas or electric motor 60 to lower or raise the brush bar 34 and to adjust the vertical height of the brush bar 34 relative to the ground to accommodate the loosening of the grass thatch of different heights.

Referring now to FIGS. 10 and 11, the mobile scorching apparatus 10 further comprises a torch or a flame blower 62 having a first flame pipe 64 and a second flame pipe 66 parallel to the first flame pipe 64. The flame blower 62 has a length substantially equivalent to the width of the chassis 14. The first flame pipe 64 includes a first end 68 and a second opposing end 70, and the second flame pipe 66 also includes a first end 72 and a second opposing end 74. The first flame pipe 64 includes a plurality of flame nozzles 76 disposed on its outer surface and along its entire length from the first end 68 to the second end 70, and the second flame pipe 66 also includes a plurality of flame nozzles 76 disposed on its outer surface and along its entire length from the first end 72 to the second end 74. The flame nozzles 76 are dimensioned and configured so that they are facing the ground for scorching of the grass.

The first end 68 of the first flame pipe 64 is fluidly connected to the first end 72 of the second flame pipe 66 and the second end 70 of the first flame pipe 64 is fluidly connected to second end 74 of the second flame pipe 66. Similar to the brush bar 34, the first ends 68, 72 are secured to a first hydraulically extending arm 78 attached to an underside of the chassis 14, and the second ends 70, 74 are attached to a second hydraulically extendible arm 80 opposite the first hydraulically extending arm 78 and to underside of the chassis 14. The first and the second hydraulically extendible arms 78, 80 are also powered by the gas or electric motor 60, and are used to adjust the height of the flame blower 62 relative to the ground. As will be explained in greater detail, the flame blower 62 is positioned to the rear of the brush bar 34.

The torch or flame blower 62 also includes a gas inlet 80 disposed at first flame pipe second end 70, which gas inlet 80 is connected to a propane tank 84 gas outlet 86 by means of a tube 88, or other suitable means. The mobile field scorching apparatus may include a second spare propane tank. The propane tanks 84 are disposed and removably secured on the upper support surface 16 of the main body 12.

The gas flow through the first and the second flame pipes 64, 66 is manually controlled by a gas valve 90 operably connected to the propane tank gas outlet 86, and the torch is lighted at the first and the second flame pipes' plurality of flame nozzles 76 in a similar manner as to turning on a stove. It is also contemplated that the flame blower may be lighted automatically using an electronic igniter.

Referring now FIGS. 8 and 11, the mobile scorching apparatus 10 further includes a water discharge apparatus 92 comprising a first water spray pipe 94, which may, alternatively, be a double parallel pipe, having a first end 96 and a second opposing end 98, a second water spray pipe 100 having a first end 102 and a second end 104, and third water spray pipe 106 having a first end 108 and a second end 110, wherein the first water spray pipe first end 96 is attached, preferably by, but not limited to, welding, to the second water spray bar first end 102, the first water spray bar second end 98 is attached to the third water spray pipe first end 108 in such a manner that water can flow through the first, the second, and third water spray pipes 94, 100, and 106.

Moreover, in a first representative embodiment of the present invention, the third water spray pipe second end 110 is attached, preferably by welding, to the first flame pipe first end 68, and the second water spray pipe second end 104 is attached, preferably by welding, to the first flame pipe second end 70. The first water spray pipe 94 includes a plurality of water discharge nozzles 112 disposed its outer surface from the first end 96 to the second end 98, and similarly the second water spray pipe 100 includes a plurality of water discharge nozzles 112 disposed on its outer surface from the first end 102 to the second end 104, and the third water spray pipe 106 includes a plurality of water discharge nozzles 112 disposed on its outer surface from the first end 108 to the second end 110. The water discharge nozzles 112 are preferably pointed downwardly towards the ground for allowing the water to be sprayed directly to the ground. As can be seen in FIG. 11, the water discharge apparatus 92 is positioned rear of the flamer blower 62, which is positioned rear the brush bar 34 relative to a forward moving direction of the mobile field scorching apparatus 10. Also, as best can be seen in FIG. 11, the configuration of the first, second, and third water spray pipes 94, 100, 06, and the flame blower 62 creates a rectangular configuration bounding an opening in the middle, which, as will be explained in greater detail, the discharged water through the second water spray pipe 100 and the third water spray pipe 106 creates a curtain to enclose the particulates and fumes within the rectangular enclosure area.

Also, since the water discharge apparatus 92 is attached to the flame blower 62, the water discharge apparatus 92 may also be raised or lowered to a desired height as the flame blower 62 is raised or lowered. Alternatively, it is contemplated that the water discharge apparatus 92 be independently secured to an underside of the chassis 14 at a fixed height relative to the ground.

Moreover, as best can be seen in FIG. 4, the water discharge apparatus 92 includes a water inlet 114, preferably positioned at the first water spray piper first end 96. A water tank 116 for holding the water supply is disposed on the upper support surface 16 and rear of the main body 12, and includes a water inlet opening 118 an a water outlet 120. A water pump 122 is also disposed on the upper support surface 16 of the main body 12 and includes a water inlet 124 and a water outlet 126. The water from the water tank 116 is supplied to the first, the second, and third water spray pipes 94, 100, 106 of the water discharge apparatus 92 by means of a first tube 128 connected to water tank outlet 120 at one end, and connected to the water pump inlet 124 at a second end, and a second tube 130 connected to the water pump outlet 126 at one end, and connected to the water discharge apparatus inlet 114 at a second end. The water pump 122 is operably connected to and powered by a gasoline generator 132 disposed on the upper support surface 16 of the main body 12.

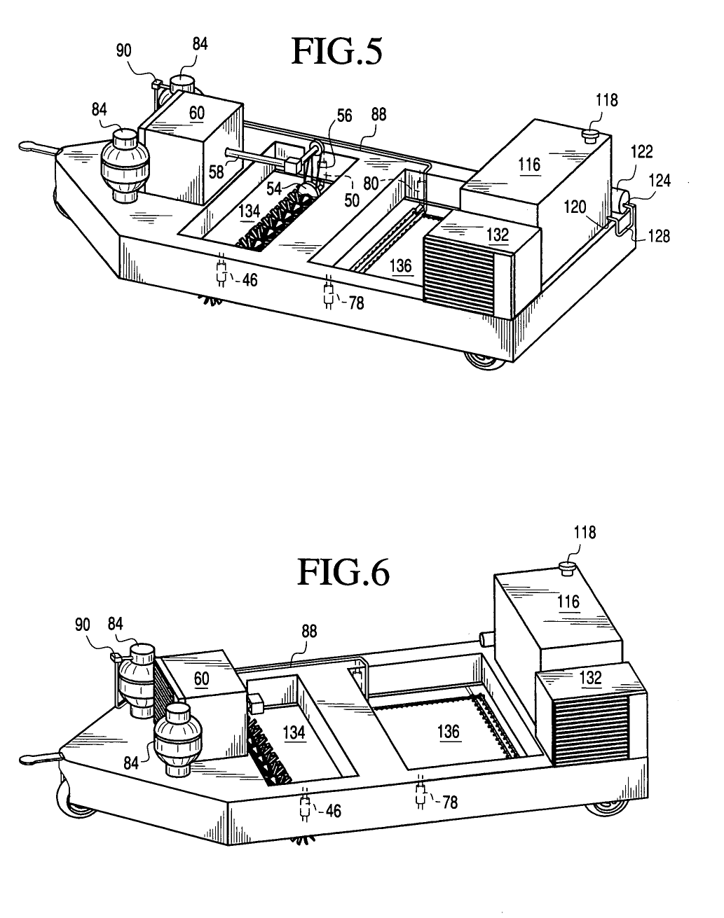

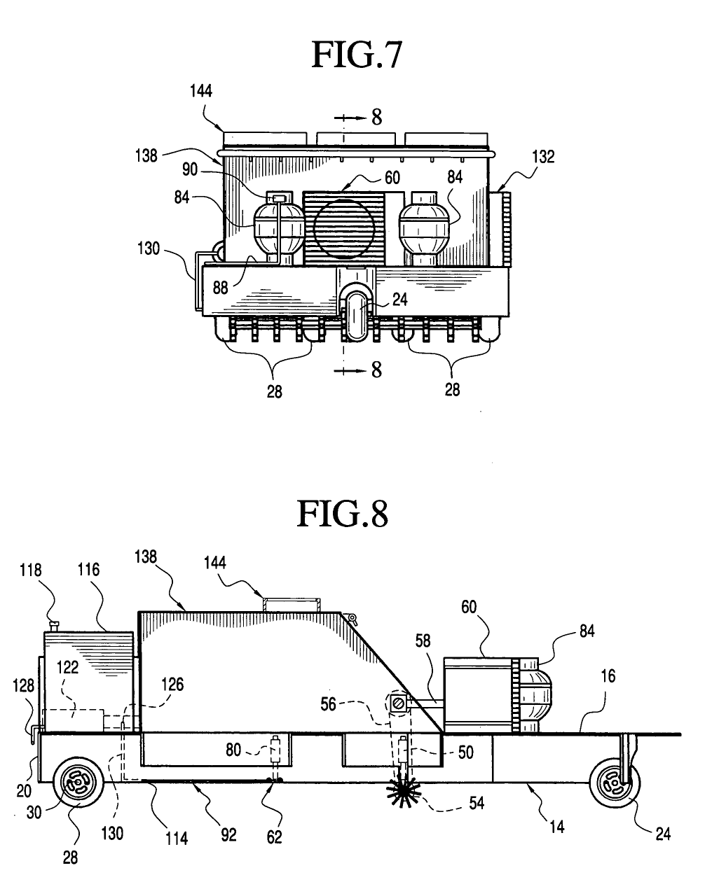

Referring now to FIGS. 5 and 6, the main body portion 12 includes a first substantially rectangular opening or cutout section 134 over the brush bar 34, and a second substantially rectangular opening or cutout section 136 over the flame blower 62 and the water discharge apparatus 92. Moreover, the mobile field scorching apparatus 10 includes a substantially cube-shaped cover portion 138 having a rear side 140 and a bottom opening 142, wherein the cover portion 138 is dimensioned and configured to be removably secured on the upper support surface 16 of the main body 12 over the first and the second openings 134, 136. The cover portion 138 includes a plurality of outlet screens 144, preferably three, disposed on the top surface, wherein each screen is preferably dimensioned, but not limited to, as 12″×12″. As will be explained, the hot air and gases that result from the scorching of the grass are filtered through the screens before being discharged into the air. The hot air travels through the cover portion 138 by convection and the screens sort out any smoke or particulates that might otherwise get into the air.

In the alternative embodiment, the gas and heat dissipated as a result of the scorching can discharged by using a fan disposed within the cover portion to force the hot air through the screen.

In use, before the mobile field scorching apparatus 10 is ready to be towed by a tractor, the gas or electric motor means 60 is started to power the rotation of the brush bar 34. Then, the propane gas tank valve 90 is opened and the first and the second flame pipes 64, 66 of the flame blower 62 are lighted, and then the gasoline generator 132 is started to power the water pump 122 so that water starts flowing through the water discharge apparatus 92 and is discharged through the nozzles 112 of the first, the second, and third water spray pipes 94, 100, 106. At this point, the mobile field scorching apparatus 10 is towed at a steady speed, preferably about five miles per hour. The brush bar 34 is lowered to a desired height by activating the first and the second hydraulically extendible support arms 46, 50, so that the rubberized fingers or teeth 40 rub on the grass and break up the thatch on the Bermuda grass. As stated hereinabove, the rotational speed of the brush bar 34 may also be adjusted to properly break up the thatch.

As the mobile field scorching apparatus 10 is moving forward at a constant speed and the thatch on the grass is being broken up, the flame blower 62 scorches the loosened up thatch. As indicated above, the temperature as to which the grass is scorched can be adjusted by lowering or raising the flame blower 62 relative to the ground, or by adjusting the gas valve 90 to reduce or increase the amount of gas flow, or by speeding up or slowing down the tractor and the speed which the mobile field scorching apparatus is being towed.

Immediately after the grass is scorched, the scorched grass is wet down primarily by the water being sprayed through the nozzles 112 on the first water spray pipe 94. The intensity of the water sprayed through the first water spray pipe 94 is greater than the water sprayed through the second water spray pipe 100 or the third water spray pipe 106, because the first water spray pipe 94 primarily distinguishes the scorched grass as well as depositing the scorched grass back into the soil. Moreover, it should be appreciated that the water sprayed through the second water spray pipe 100 and the third water spray pipe 106 creates a curtain to keep the scorched particulates, as well as fumes and smoke from the scorched grass, within the rectangular perimeter of the flame blower 62, the first, second, and third water spray pipes, 94, 100, and 106. Therefore, particulates cannot escape through the sides of mobile scorching field apparatus, and can only escape through the first and the second openings 134, and 136 through the cover portion 134 and out into the air through outlet screens 144.

While preferred embodiments of the invention have been shown and described, various modifications and substitutions may be made thereto without departing from the spirit and scope of the invention. Accordingly, it is to be understood that the present invention has been described by way of illustration only, and this description should not be construed as limiting to the several claims appended hereto.

1. A mobile field scorching apparatus, comprising:
a chassis;
a plurality of wheels rotatably supporting said chassis on the ground;
a main body disposed on said chassis;
a brush bar rotatably attached to said chassis for loosening the thatch on a grass area;
a flame blower operably attached to said chassis rear said brush bar for scorching the loosened grass thatch; and,
a water discharge apparatus operably attached to said chassis rear said flame blower for wetting down and curtaining the scorched grass.

2. The mobile field scorching apparatus of claim 1, wherein the brush bar further comprises an axle having first end and second ends, and a plurality of brush segments removably disposed on an outer surface of said axle and along the length thereof.

3. The mobile field scorching apparatus of claim 2, wherein each of said plurality of brush segments further comprises a plurality of teeth circumferentially disposed on said outer surface of said axle.

4. The mobile field scorching apparatus of claim 3, further comprising first and second hydraulically extendible arms operably attached to said chassis, wherein said first end of said axle is secured to said first hydraulically extendible arm and said second end of said axle is secured to said second hydraulically extendible arm, wherein said first and the second hydraulically extendible arms adjust the height of said brush bar relative to ground.

5. The mobile field scorching apparatus of claim 3, further comprising a motor means for providing rotational power to said brush bar.

6. The mobile field scorching apparatus of claim 4, wherein said rotational power is transferred by a belt or a chain.

7. The mobile field scorching apparatus of claim 6, wherein said first and said second hydraulically extendible support arms are powered by said motor means.

8. The mobile field scorching apparatus of claim 1, wherein said flame blower further comprises first flame pipe having a first end and a second end, and a second flame pipe having a first end and a second end, wherein each of said first and said second flame pipes comprises a plurality of flame nozzles.

9. The mobile field scorching apparatus of claim 8, further comprising a propane tank having a valve, a tube having a first end and a second end, wherein said first end of said tube is attached to said propane tank valve and said second end of said tube is attached to said first flame pipe of said flame blower.

10. The mobile field scorching apparatus of claim 9, further comprising a third hydraulically extendible arm operably attached to said chassis and a fourth hydraulically extendible arm operably attached to said chassis, wherein a first end of said flame blower is attached to said third hydraulically extendible arm and a second end of said flame blower is attached to said fourth hydraulically extendible arm for lowering a raising said flame blower.

11. The mobile field scorching apparatus of claim 1, wherein said water discharge apparatus further includes a first water spray pipe having a first end and a second end, a second water spray pipe having a first end and a second end, and a third water spray pipe having a first end and a second end, wherein said first water spray pipe first end is attached to said second water spray pipe first end, and said first water spray pipe second end is attached to said third water spray pipe first end.

12. The mobile field scorching apparatus of claim 11, wherein each of said first, said second, and said third water spray pipes includes a plurality of water discharge nozzles.

13. The mobile field scorching apparatus of claim 12, wherein said second water spray pipe second end is attached to said first flame pipe first end, and said third water spray pipe second end is attached to said first flame pipe second end creating a rectangular opening bound by said first, said second, said third water spray pipes and said first flame pipe, and wherein water discharged from said second and said third water spray pipes creates a curtain to enclose scorched particulates within said rectangular opening.

14. The mobile field scorching apparatus of claim 13, further comprising a water tank and water pump for supplying water to said water discharge apparatus.

15. The mobile field scorching apparatus of claim 14, further comprising a generator for powering said water pump.

16. The mobile field scorching apparatus of claim 15, wherein said main body includes a first opening disposed on said flame blower and a second opening disposed on said brush bar and said water discharge mechanism.

17. The mobile field scorching apparatus of claim 16, further comprising a cover portion disposed on said main body over said first and said second openings.

18. The mobile field scorching apparatus of claim 17, wherein said cover portion includes a discharge air screen.
